(19) United States
(12) Patent Application Publication
(10) Pub. No.: US 2026/0369941 A1
(43) Pub. Date: Nov. 19, 2026

(54) SHIELD TERMINAL

(71) Applicant: SUMITOMO WIRING SYSTEMS, LTD., Mie (JP)

(72) Inventor: Wataru YAMANAKA, Mie (JP)

(21) Appl. No.: 19/126,649

(22) PCT Filed: Oct. 20, 2023
(86) PCT No.: PCT/JP2023/038070

§ 371 Date: May 2, 2025

(30) Foreign Application Priority Data
Nov. 10, 2022 (JP) 2022-180180

(51) Int. Cl. H01R 24/44; H01R 103/00

(52) U.S. Cl. CPC H01R 24/44; H01R 2103/00

(57) ABSTRACT

An inner conductor of a shield terminal has a partner connecting portion, an electric wire connecting portion, and a coupling portion disposed between the partner connecting portion and the electric wire connecting portion, the coupling portion has a base wall portion coupled to the partner connecting portion and the electric wire connecting portion, and a sidewall portion extending upward from the base wall portion, the partner connecting portion extends with respect to the coupling portion in a direction intersecting an alignment direction of the coupling portion and the electric wire connecting portion, the dielectric has a housing portion, and the housing portion has a first housing portion, a second housing portion intersecting the first housing portion, and an insertion opening that is open at an end portion on one side of the first housing portion and the second housing portion.

### TECHNICAL FIELD

The present disclosure relates to a shield terminal.

### BACKGROUND

Patent Document 1 discloses an inner terminal with an impedance adjustment portion provided between an electrical connection portion and a crimp barrel portion. The impedance adjustment portion includes a bottom plate portion that is provided between the electrical connection portion and the crimp barrel portion and is continuous with the electrical connection portion and the crimp barrel portion, and a pair of side plate portions that extend upward from opposite sides of the bottom plate portion. The impedance adjustment portion is formed to be substantially U-shaped.

### PRIOR ART DOCUMENT

### Patent Document

Patent Document 1: JP 2013-137974 A

### SUMMARY OF THE INVENTION

### Problems to Be Solved

The impedance adjustment portion of Patent Document 1 is mated with a mating groove of an inner housing (attachment target). Relative positions of the inner housing and the inner terminal are determined by plate ends of the bottom plate portion and the side plate portions abutting against the mating groove in the axial direction of the inner terminal. However, when the side plate portions are bent so as to extend upward from the bottom plate portion in the process of forming the inner terminal, compressive stress is applied to the plate ends of the bent portions. As shown in FIG. 8, when this occurs, the plate ends may deform so as to protrude in the axial direction of the inner terminal, as with a corner portion C where the bottom plate portion and the side plate portion are coupled. Thus, it can be said that the plate ends of the bent portions are parts with low dimensional accuracy. Accordingly, bringing the corner portion C, where the bottom plate portion and the side plate portion are coupled, into contact with the inner housing from the axial direction in order to position the inner terminal and the inner housing is not preferable.

In view of this, an object of the present disclosure is to provide a shield terminal capable of improving positional accuracy when an inner conductor is assembled to a dielectric, while achieving impedance adjustment.

### Means to Solve the Problem

A shield terminal according to the present disclosure includes an inner conductor, an outer conductor, and a dielectric disposed between the inner conductor and the outer conductor, the inner conductor having a partner connecting portion that is connected to a partner inner conductor, an electric wire connecting portion that is connected to an electric wire, and a coupling portion disposed between the partner connecting portion and the electric wire connecting portion, the coupling portion having a base wall portion coupled to the partner connecting portion and the electric wire connecting portion, and a sidewall portion extending upward from the base wall portion, the partner connecting portion having a shape extending with respect to the coupling portion in a direction intersecting an alignment direction of the coupling portion and the electric wire connecting portion, the dielectric having a housing portion housing the inner conductor, and the housing portion having a first housing portion housing the coupling portion and the electric wire connecting portion, a second housing portion intersecting the first housing portion and housing the partner connecting portion, and an insertion opening open at an end portion on one side of the first housing portion and the second housing portion, and the first housing portion having, at an end portion on another side opposing the insertion opening, a stopper surface facing a wall surface of the sidewall portion in a contactable manner.

### Effect of the Invention

According to the present disclosure, positional accuracy when assembling an inner conductor to a dielectric can be improved, while achieving impedance adjustment of a connector.

### BRIEF DESCRIPTION OF THE DRAWINGS

FIG. 1 is a side cross-sectional view showing a housed state where a shield terminal of a first embodiment is housed in a housing.

FIG. 2 is a side view of an inner conductor.

FIG. 3 is a perspective view of the inner conductor.

FIG. 4 is a side view of the shield terminal.

FIG. 5 is a perspective view of a dielectric with a lid portion in an open state.

FIG. 6 is a perspective view of the open dielectric assembled to an open second outer conductor.

FIG. 7 is a side cross-sectional view showing a state in which the inner conductor with an electric wire attached thereto is assembled to the open dielectric assembled to the open second outer conductor.

FIG. 8 is an enlarged perspective view of a corner portion where a bottom plate portion and a side plate portion are coupled in FIG. 2 of Patent Document 1.

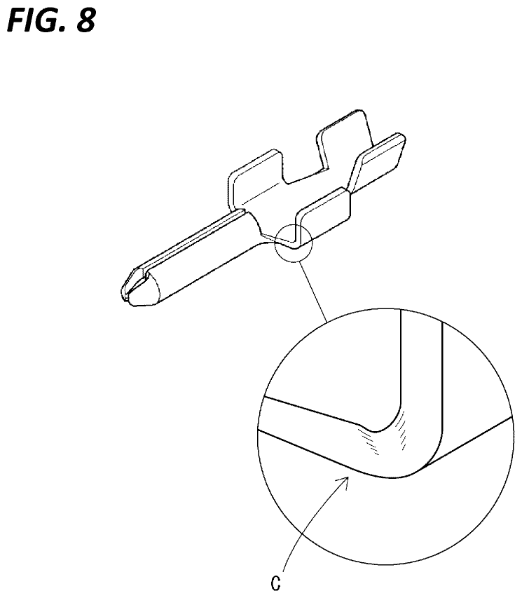

### DETAILED DESCRIPTION TO EXECUTE THE INVENTION

### Description of Embodiments of Disclosure

Initially, embodiments of the present disclosure will be listed and described.
(1) A shield terminal according to the present disclosure includes an inner conductor, an outer conductor, and a dielectric disposed between the inner conductor and the outer conductor, the inner conductor having a partner connecting portion that is connected to a partner inner conductor, an electric wire connecting portion that is connected to an electric wire, and a coupling portion disposed between the partner connecting portion and the electric wire connecting portion. The coupling portion has a base wall portion coupled to the partner connecting portion and the electric wire connecting portion, and sidewall portion extending upward from the base wall portion, and the partner connecting portion has a shape extending with respect to the coupling portion in a direction intersecting an alignment direction of the coupling portion and the electric wire connecting portion. The dielectric has a housing portion housing the inner conductor. The housing portion has a first housing portion housing the coupling portion and the electric wire connecting portion, a second housing portion intersecting the first housing portion and housing the partner connecting portion, and an insertion opening open at an end portion on one side of the first housing portion and the second housing portion. The first housing portion has, at an end portion on another side opposing the insertion opening, a stopper surface facing a wall surface of the sidewall portion in a contactable manner.

With this configuration, the inner conductor is inserted into the housing portion through the insertion opening. Due to the wall surface of the sidewall portion of the inner conductor contacting the stopper surface of the first housing portion, the inner conductor is housed in the first housing portion with high positional accuracy. As a result, displacement of the axis of the partner connecting portion housed in the second housing portion can be suppressed, and the partner connecting portion is properly connected to the partner inner conductor. Also, impedance adjustment can be performed, by adjusting the shape of the sidewall portion extending upward from the base wall portion.
(2) Preferably the electric wire connecting portion has a barrel piece extending upward from the base wall portion, and one end of the sidewall portion is coupled to the barrel piece.

With this configuration, deformation is unlikely to occur when the sidewall portion abuts the stopper surface of the first housing portion. An air layer is reduced by coupling one end of the sidewall portion to the barrel piece, as compared with the case where one end of the sidewall portion and the barrel piece are not coupled to each other and a space exists therebetween, thus enabling the impedance of the inner conductor to be reduced.
(3) Preferably the dielectric has a lid portion capable of opening and closing the insertion opening, and the inner conductor has a contacting portion that contacts the lid portion in a closed state.

With this configuration, the contacting portion of the inner conductor comes in contact with the lid portion and the coupling portion is accurately disposed between the lid portion and the stopper surface.
(4) Preferably the contacting portion has a shape that partially blocks the insertion opening at the end portion on the one side relative to the partner connecting portion.

With this configuration, the partner connecting portion can be inserted into the second housing portion by pressing the contacting portion when housing the inner conductor in the housing portion. Then, after insertion, the partner connecting portion can be held in the second housing portion. Since the contacting portion has both a function of contacting the lid portion and a function of being pressed by the lid portion during assembly, the overall configuration can be simplified, as compared with the case where both functions are provided in separate portions.

### Detailed Description of Embodiments of Disclosure

### First Embodiment

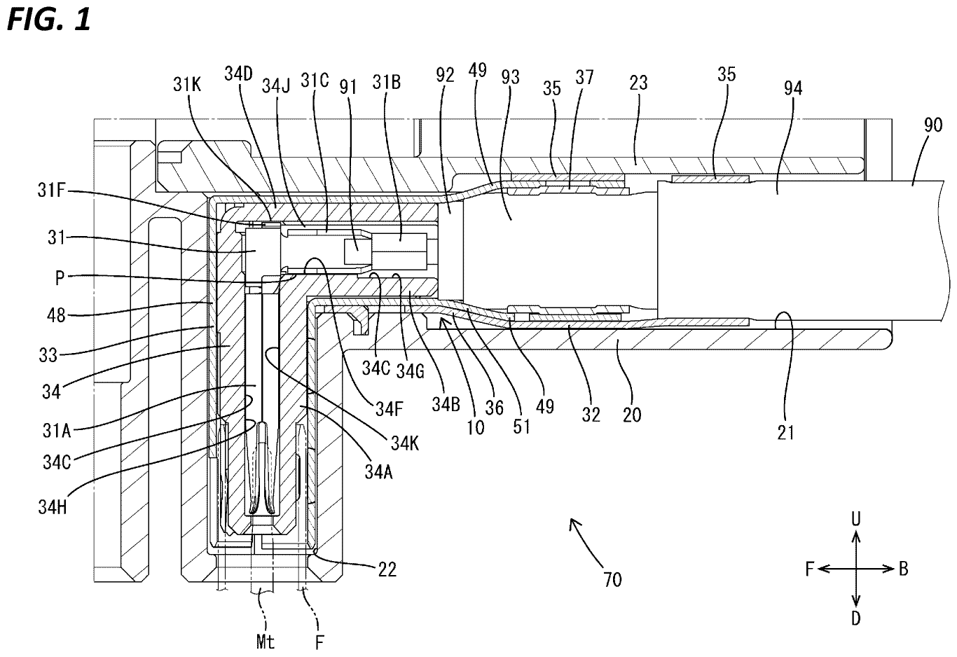

The following describes a shield terminal 10 embodying the present disclosure with reference to FIG. 1 to FIG. 7. In the drawings, “front side,” “back side,” “upside,” “downside,” “right side,” and “left side” are represented by “F,” “B,” “U,” “D,” “R,” and “L,” respectively. As shown in FIG. 1, the shield terminal 10 in the first embodiment is provided in a connector 70 and is housed in a housing 20.

### <Housing>

The housing 20 is made of synthetic resin. As shown in FIG. 1, the housing 20 has a housing recess portion 21 extending in the front-back direction, and an inserting portion 22 extending downward from a front end portion of the housing recess portion 21. The housing recess portion 21 is entirely open upward in the front-back direction. A covering member 23, such as a cover or a separate housing, is attached to the housing 20 from above in order to block the housing recess portion 21.

### <Electric Wire>

An electric wire 90 is a shield electric wire (coaxial electric wire), and has a core wire 91, an insulation covering 92, a shield portion 93, and a sheath 94 from a central axis to an outer periphery. The sheath 94 and the insulation covering 92 are cut away and the core wire 91 and the shield portion 93 are exposed successively at a front end portion of the electric wire 90. The shield portion 93 is a braided wire, for example.

### <Shield Terminal>

The shield terminal 10 has an inner conductor 31, a first outer conductor 32 and a second outer conductor 33 which are outer conductors that surround an outer periphery of the inner conductor 31, and a dielectric 34. The inner conductor 31, the second outer conductor 33, and the dielectric 34 are all L-shaped in side view, and correspond to an overall shape of the shield terminal 10. The first outer conductor 32, the second outer conductor 33, and the inner conductor 31 are made of a metal with conductivity. The dielectric 34 is made of a synthetic resin. The dielectric 34 houses the inner conductor 31 and electrically insulates the first outer conductor 32 and the second outer conductor 33 from the inner conductor 31.

### <Inner Conductor>

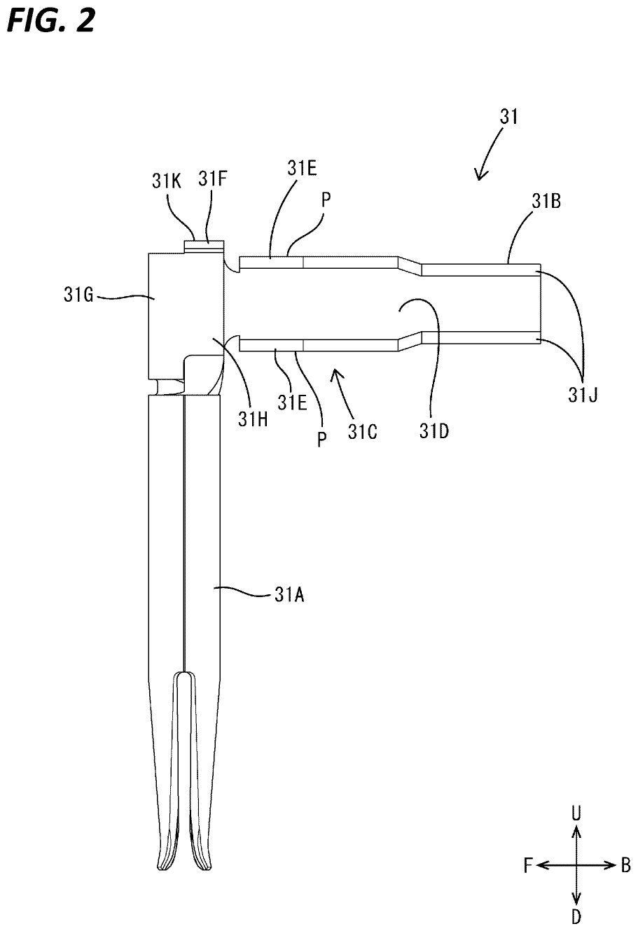

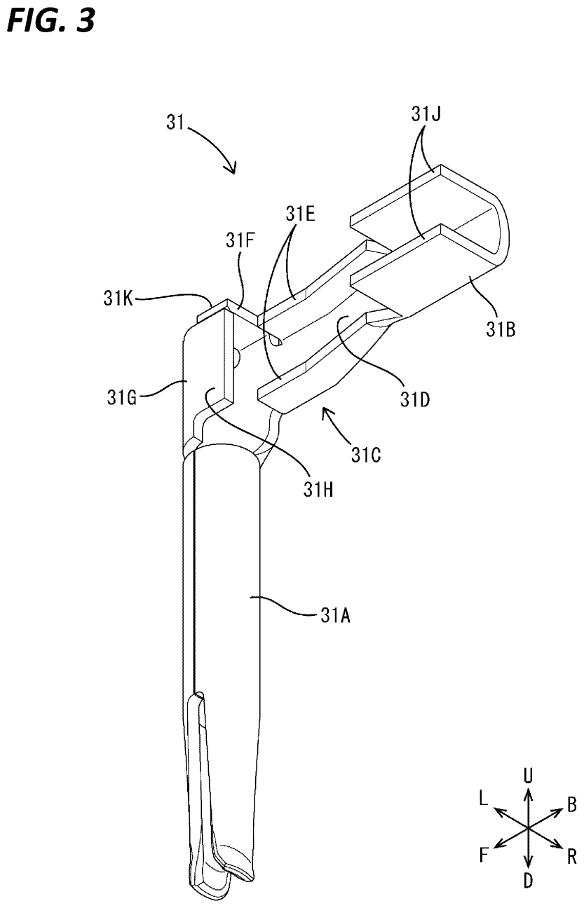

The inner conductor 31 is formed by processing such as bending a metal plate. As shown in FIG. 2 and FIG. 3, the inner conductor 31 has a partner connecting portion 31A that is cylindrical and extends in the up-down direction, an electric wire connecting portion 31B that is coupled to the electric wire 90, and a coupling portion 31C that is disposed between the partner connecting portion 31A and the electric wire connecting portion 31B. A lower part of the partner connecting portion 31A is forked and elastically contacts a partner inner conductor Mt when the partner inner conductor Mt is inserted therein (see FIG. 1). The electric wire connecting portion 31B has an open barrel shape with a pair of barrel pieces 31J and is conductively connected by crimping to the core wire 91 of the electric wire 90 (see FIG. 1).

The coupling portion 31C has a base wall portion 31D coupled to the partner connecting portion 31A and the electric wire connecting portion 31B, a pair of sidewall portions 31E coupled to the base wall portion 31D so as to extend upward relative to the base wall portion 31D, a contacting portion 31F coupled to the base wall portion 31D so as to extend upward relative to the base wall portion 31D, and a bent portion 31G. The base wall portion 31D has a plate shape with a plate surface thereof facing in the left-right direction and extends rearward continuously with an upper end of the partner connecting portion 31A. The electric wire connecting portion 31B extends rearward from a rear end of the base wall portion 31D, with the pair of barrel pieces 31J extending upward from a part thereof extending continuously with the base wall portion 31D. The barrel pieces 31J are connected by crimping to the core wire 91 of the electric wire 90.

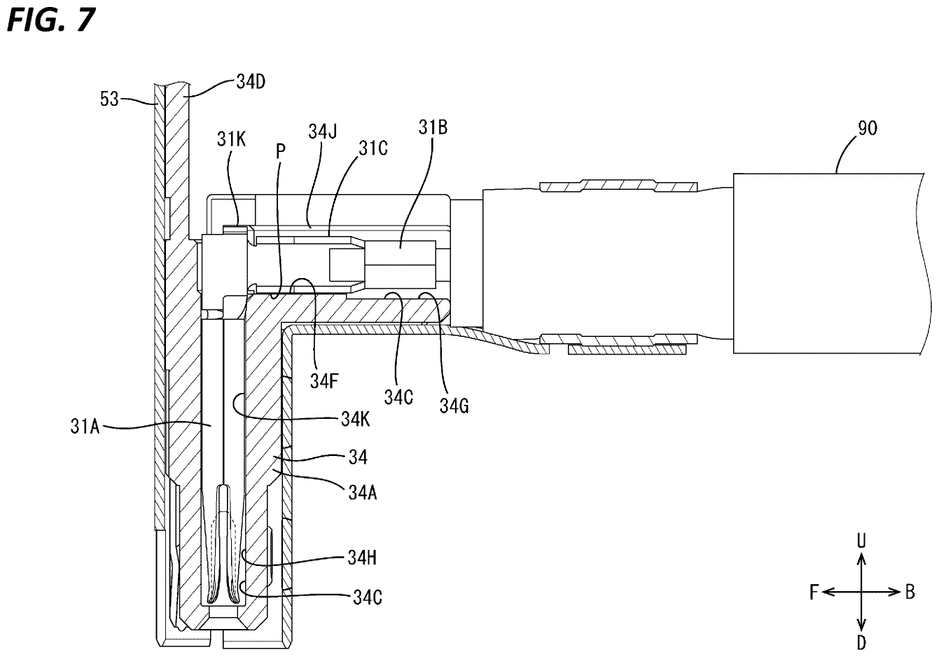

The pair of sidewall portions 31E extend upward from upper and lower end portions of the base wall portion 31D and are disposed so as to face each other in the up-down direction. Rear ends (one end) of the pair of sidewall portions 31E are respectively coupled to front ends of the pair of barrel pieces 31J. A front end (other end) of the upper sidewall portion 31E is disposed behind and below the contacting portion 31F, which will be described later, and is adjacent to the contacting portion 31F. The sidewall portions 31E have upper and lower wall surfaces P that are orthogonal to a wall surface of the base wall portion 31D and extend along the front-back and left-right directions (see FIG. 2). When the inner conductor 31 is housed in the dielectric 34, a lower wall surface P (wall surface P directed downward) of the lower sidewall portion 31E faces a stopper surface 34F, which will be described later, of the dielectric 34 in a contactable manner (see FIG. 7).

The contacting portion 31F is continuous with an upper end edge of a front end portion of the base wall portion 31D. The contacting portion 31F is disposed adjacent to a front part of the upper sidewall portion 31E and protrudes upward to a level higher than the upper sidewall portion 31E (see FIG. 2). The contacting portion 31F extends leftward so as to be orthogonal to a plate surface at the front end of the base wall portion 31D. The contacting portion 31F is disposed at the uppermost position in the inner conductor 31. A back surface 31K of the contacting portion 31F is a surface that is contactable with a closed lid portion 34D which will be described later (see FIG. 1), and is also a surface that is pressed when the inner conductor 31 is inserted into a housing portion 34C which will be described later.

The bent portion 31G is continuous with the front end edge of the base wall portion 31D. The bent portion 31G is formed to curve with the same curvature radius as the partner connecting portion 31A. The bent portion 31G is coaxially aligned with the partner connecting portion 31A upward of the partner connecting portion 31A. The bent portion 31G and the partner connecting portion 31A are spaced apart in the up-down direction. A flat portion 31H that is flat and extends rearward is continuous with the front end edge of the bent portion 31G. The plate surface of the flat portion 31H faces in parallel to the plate surface of the base wall portion 31D. A lower end edge of the flat portion 31H is positioned higher than the lower end edge of the bent portion 31G. A vertical gap between the flat portion 31H and the partner connecting portion 31A is larger than a vertical gap between the bent portion 31G and the partner connecting portion 31A (see FIG. 2). In the inner conductor 31 constituted in such a manner, the partner connecting portion 31A has a shape extending with respect to the coupling portion 31C in a direction intersecting an alignment direction of the coupling portion 31C and the electric wire connecting portion 31B.

### <Outer Conductor>

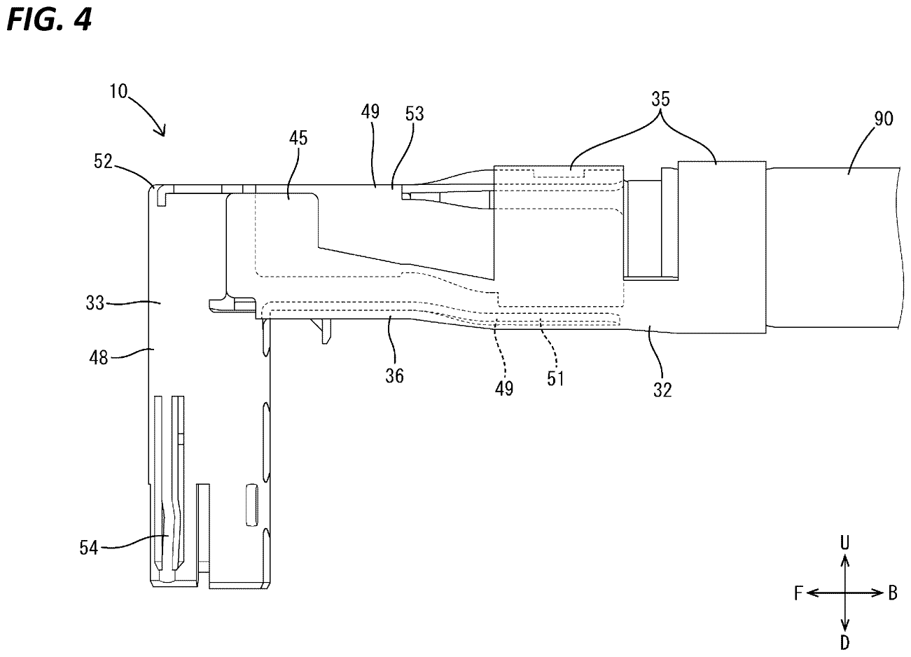

As shown in FIG. 4, the first outer conductor 32 and the second outer conductor 33 constitute an outer shell of the shield terminal 10 and are assembled and coupled to each other. The first outer conductor 32 is formed by processing such as bending a metal plate. The first outer conductor 32 has a barrel portion 35 and a base portion 36 extending forward from the barrel portion 35. The barrel portion 35 is coupled by crimping to the electric wire 90. A pair of upward extension portions 45 extending upward are provided at right and left end portions of the base portion 36.

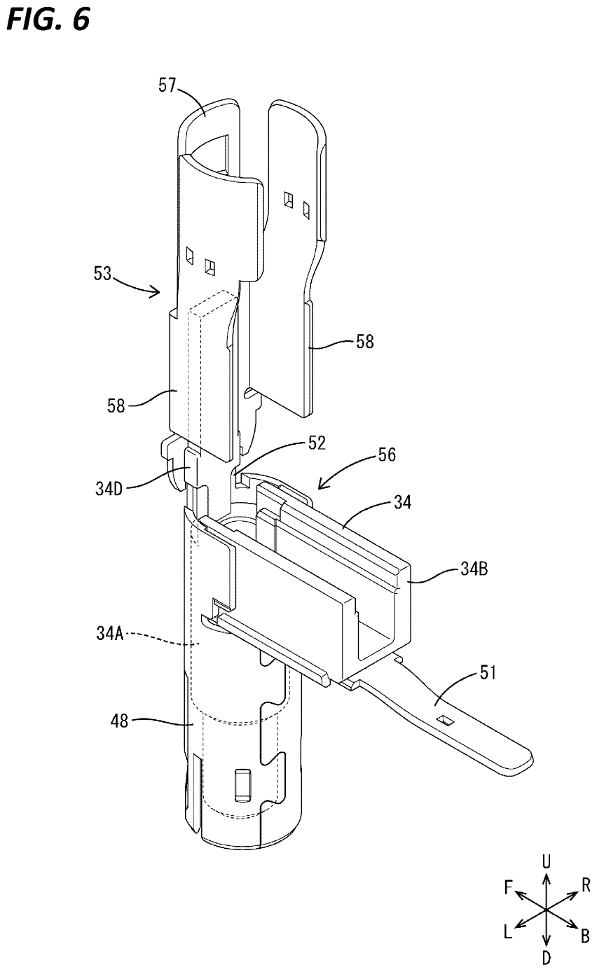

The second outer conductor 33 is formed by processing such as bending a metal plate. The second outer conductor 33 has a cylindrical main body portion 48 and an extension portion 49 having a plate-piece shape. The extension portion 49 has a lower extension portion 51 continuous with the main body portion 48 at a right angle, and an upper extension portion 53 continuous with the main body portion 48 via a hinge 52 so as to be openable and closable into an open state and a closed state. In the open state, the upper extension portion 53 adopts an upwardly extending posture along the up-down direction upward of the main body portion 48 (see FIG. 6). An upper end opening of the main body portion 48 is thereby open upward. In the closed state, the upper extension portion 53 is continuous with the main body portion 48 at a right angle via the hinge 52, and adopts a prone posture along the front-back direction (see FIG. 4). The upper end opening of the main body portion 48 is thereby blocked by a base end portion of the upper extension portion 53 (see FIG. 4).

The main body portion 48 is electrically connected to a partner outer conductor F when inserted into the inserting portion 22 of the housing 20 (see FIG. 1). An elastic contacting portion 54 is formed at a lower part of the main body portion 48 that is contactable with the partner outer conductor F disposed within the main body portion 48.

As shown in FIG. 6, the lower extension portion 51 extends rearward from a lower end of an open portion 56 formed at an upper end portion of the main body portion 48. The upper extension portion 53 has a main extension portion 57 having a plate-piece shape continuous with an upper end on a front side of the main body portion 48 via the hinge 52, and a pair of auxiliary extension portions 58 each bent at a right angle from right and left end portions of the main extension portion 57.

### <Dielectric>

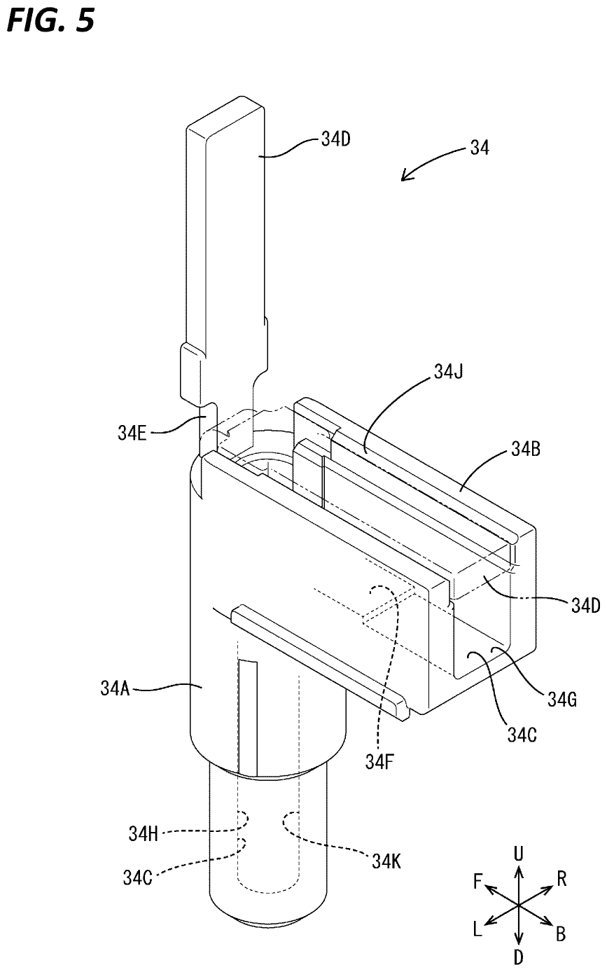

As shown in FIG. 5, the dielectric 34 has an inserting portion 34A formed in a cylindrical shape and extending in the up-down direction, a dielectric main body portion 34B formed in a rectangular tube shape and extending in the front-back direction, and the lid portion 34D. On the inside of the inserting portion 34A and the inside of the dielectric main body portion 34B is the housing portion 34C where the partner connecting portion 31A, the electric wire connecting portion 31B and the coupling portion 31C of the inner conductor 31 are housed (see FIG. 1). Specifically, the inside of the inserting portion 34A is formed as a second housing portion 34H where the partner connecting portion 31A of the inner conductor 31 is housed (see FIG. 1). The inside of the dielectric main body portion 34B is formed as a first housing portion 34G where the electric wire connecting portion 31B and the coupling portion 31C of the inner conductor 31 are housed (see FIG. 1). That is, the housing portion 34C is constituted by the first housing portion 34G and the second housing portion 34H.

A front end portion of the dielectric main body portion 34B is continuous with an upper end portion of the inserting portion 34A. The inside of the dielectric main body portion 34B and the inside of the inserting portion 34A (i.e., first housing portion 34G and second housing portion 34H) communicate with each other (see FIG. 1). An insertion opening 34J that is open upward and into which the inner conductor 31 is inserted is formed at an end portion on the upper side (one side) of the first housing portion 34G and the second housing portion 34H. A stopper surface 34F formed at an end portion on the lower side (other side) of the first housing portion 34G that faces the insertion opening 34J. The stopper surface 34F is disposed orthogonal to a wall surface 34K (rear inner wall surface) that demarks the second housing portion 34H for housing the partner connecting portion 31A along the front-back direction and the right-left direction (see FIG. 1). The wall surface 34K is part of the second housing portion 34H.

The lid portion 34D is coupled to a front side of the upper end of the inserting portion 34A via a hinge portion 34E. The lid portion 34D is configured to be openable and closable around the hinge portion 34E. When the lid portion 34D of the dielectric main body portion 34B is in the open state, the lid portion 34D adopts an upwardly extending posture along the up-down direction. Accordingly, the second housing portion 34H of the inserting portion 34A and the first housing portion 34G (insertion opening 34J) of the dielectric main body portion 34B are open upward. At this time, the partner connecting portion 31A can be inserted inside the inserting portion 34A (second housing portion 34H) from above through the insertion opening 34J, and the electric wire connecting portion 31B and the coupling portion 31C of the inner conductor 31 can be inserted inside the dielectric main body portion 34B (first housing portion 34G) from above through the insertion opening 34J.

When the lid portion 34D of the dielectric main body portion 34B is in the closed state, the lid portion 34D adopts a prone posture along the front-back direction (lid portion 34D indicated by a two-dot chain line in FIG. 5). The upper end of the inserting portion 34A and the upper end of the dielectric main body portion 34B (insertion opening 34J) are thereby closed by the lid portion 34D. At this time, insertion of the partner connecting portion 31A into the inserting portion 34A and insertion of the electric wire connecting portion 31B and the coupling portion 31C inside the dielectric main body portion 34B are positioned.

### <Assembly Method and Assembly Configuration of Shield Terminal>

First, the dielectric 34 is assembled to the second outer conductor 33. Specifically, as shown in FIG. 6, the inserting portion 34A of the dielectric 34 with the lid portion 34D open is inserted from above into the main body portion 48 of the second outer conductor 33 with the upper extension portion 53 open. At this time, the open lid portion 34D is positioned so as to overlap the open upper extension portion 53 when viewed from behind. Also, the dielectric main body portion 34B is positioned so as to overlap the lower extension portion 51 of the second outer conductor 33 when viewed from above.

Next, the inner conductor 31 with the pair of barrel pieces 31J crimped to the core wire 91 of the electric wire 90 is housed in the dielectric 34. Specifically, as shown in FIG. 7, the back surface 31K of the contacting portion 31F is pressed with a jig, a finger or the like, and the inner conductor 31 is inserted into the housing portion 34C such that the partner connecting portion 31A is inserted into the second housing portion 34H from above. The electric wire connecting portion 31B and the coupling portion 31C are inserted inside the dielectric main body portion 34B (first housing portion 34G). When insertion proceeds, the wall surface P of the lower sidewall portion 31E of the coupling portion 31C faces the stopper surface 34F in a surface-contactable manner.

At this time, the wall surface P of the lower sidewall portion 31E of the coupling portion 31C comes in surface contact with the stopper surface 34F of the first housing portion 34G. The inner conductor 31 is thereby positioned downward with respect to the dielectric 34, and housing of the inner conductor 31 in the housing portion 34C of the dielectric 34 is completed. At this time, the inner conductor 31 is in a housed state of being housed in the housing portion 34C of the dielectric 34. In the housed state, the wall surface P of the lower sidewall portion 31E comes in surface contact with the stopper surface 34F from above. The contacting portion 31F partially blocks the insertion opening 34J at an end portion on the upper side (one side) with respect to the partner connecting portion 31A (see FIG. 7). The housing portion 34C is open in an orientation opposite to the stopper surface 34F with which the wall surface P of the lower sidewall portion 31E is in surface contact. Here, surface contact is not limited to a state in which the opposing surfaces are in close contact with each other, and also includes a state in which the opposing surfaces are spaced slightly apart from each other. Also, due to the wall surface P of the sidewall portion 31E being in surface contact with the stopper surface 34F, a state in which the partner connecting portion 31A which is continuous with the coupling portion 31C is disposed along the up-down direction without tilting inside the second housing portion 34H can be realized.

Next, the open lid portion 34D is closed. As shown in FIG. 1, when closed, the lid portion 34D adopts a prone posture along the front-back direction and closes the open side of the housing portion 34C from above. In other words, the upper end of the inserting portion 34A and the upper end of the dielectric main body portion 34B (i.e., insertion opening 34J) are closed by the lid portion 34D. When the coupling portion 31C is housed in the first housing portion 34G, the back surface 31K of the contacting portion 31F of the coupling portion 31C is in surface contact, from the lower side (from the first receiving portion 34G side), with the closed lid portion 34D closing the housing portion 34C. Upward movement of the inner conductor 31 relative to the dielectric 34 is thereby regulated. The open upper extension portion 53 is then closed. The closed upper extension portion 53 adopts a prone posture along the front-back direction. Note that the upper extension portion 53 and the lid portion 34D may be switched from the open state to the closed state at the same time.

If the wall surface P of the sidewall portion 31E is spaced apart from the stopper surface 34F upward thereof, the contacting portion 31F is pressed downward by the lid portion 34D, when the lid portion 34D is in the closed state, and the wall surface P contacts the stopper surface 34F. The coupling portion 31C is thereby positioned to be sandwiched between the lid portion 34D and the stopper surface 34F in the up-down direction. Also, a situation in which the inner conductor 31 is left in a state of being partially inserted in the housing portion 34C can be prevented.

Next, the first outer conductor 32 is assembled to the second outer conductor 33 from below. The base portion 36 of the first outer conductor 32 is disposed along the lower surface of the lower extension portion 51 of the second outer conductor 33 (see FIG. 4). In this state, crimping is performed by applying a crimping die (anvil and crimper) to the barrel portion 35. Specifically, the barrel portion 35 on the front side is conductively connected to the shield portion 93 of the electric wire 90, with the back end portion of the extension portion 49 of the second outer conductor 33 and a circular sleeve 37 inserted therebetween. The barrel portion 35 on the rear side is mechanically connected to the sheath 94 of the electric wire 90. In such a manner, the first outer conductor 32 and the second outer conductor 33 surround the dielectric 34 and the inner conductor 31 (see FIG. 1). The dielectric 34 is disposed between the inner conductor 31 and the first and second outer conductors 32 and 33.

### <Structure for Housing Shield Terminal in Housing>

When the shield terminal 10 is housed in the housing 20, the main body portion 48 is inserted into the inserting portion 22 of the housing 20, and the first outer conductor 32 is disposed along the lower surface of the housing recess portion 21 of the housing 20. After housing of the shield terminal 10 in the housing 20 is completed, the covering member 23 is attached from above.

Next, effects of the first embodiment will be described.

The shield terminal 10 of the present disclosure includes the inner conductor 31, the first and second outer conductors 32 and 33, and the dielectric 34 disposed between the inner conductor 31 and the first and second outer conductors 32 and 33. The inner conductor 31 has the partner connecting portion 31A connected to the partner inner conductor Mt, the electric wire connecting portion 31B connected to the electric wire 90, and the coupling portion 31C disposed between the partner connecting portion 31A and the electric wire connecting portion 31B. The coupling portion 31C has the base wall portion 31D coupled to the partner connecting portion 31A and the electric wire connecting portion 31B, and the sidewall portion 31E extending upward from the base wall portion 31D. The partner connecting portion 31A has a shape extending with respect to the coupling portion 31C in a direction intersecting the alignment direction of the coupling portion 31C and the electric wire connecting portion 31B. The dielectric 34 has the housing portion 34C that houses the inner conductor 31. The housing portion 34C has the first housing portion 34G that houses the coupling portion 31C and the electric wire connecting portion 31B, the second housing portion 34H that intersects the first housing portion 34G and houses the partner connecting portion 31A, and the insertion opening 34J that is open at the end portion on one side of the first housing portion 34G and the second housing portion 34H. The first housing portion 34G has, at the end portion on the other side opposing the insertion opening 34J, the stopper surface 34F that faces the wall surface P of the sidewall portion 31E in a contactable manner.

With this configuration, the inner conductor 31 is inserted into the housing portion 34C through the insertion opening 34J. Due to the wall surface P of the sidewall portion 31E contacting the stopper surface 34F of the first housing portion 34G, the inner conductor 31 is housed in the housing portion 34C with high positional accuracy. As a result, displacement of the axis of the partner connecting portion 31A housed in the second housing portion 34H can be suppressed, and the partner connecting portion 31A is properly connected to the partner inner conductor Mt. Also, impedance adjustment can be performed, by adjusting the shape of the sidewall portion 31E.

The electric wire connecting portion 31B has the barrel piece 31J extending upward from the base wall portion 31D, and one end of the sidewall portion 31E is coupled to the barrel piece 31J. With this configuration, deformation is unlikely to occur when the sidewall portion 31E abuts the stopper surface 34F of the first housing portion 34G. An air layer is reduced by coupling one end of the sidewall portion 31E to the barrel piece 31J, as compared with the case where one end of the sidewall portion 31E and the barrel piece 31J are not coupled to each other and a space exists therebetween, thus enabling in the impedance of the inner conductor 31 to be reduced.

The dielectric 34 has the lid portion 34D capable of opening and closing the insertion opening 34J, and the inner conductor 31 has the contacting portion 31F that contacts the lid portion 34D in the closed state. With this configuration, the contacting portion 31F of the inner conductor 31 comes in contact with the lid portion 34D and the coupling portion 31C is accurately disposed between the lid portion 34D and the stopper surface 34F.

The contacting portion 31F has a shape that partially blocks the insertion opening 34J at the end portion on the one side relative to the partner connecting portion 31A. With this configuration, the partner connecting portion 31A can be inserted into the second housing portion 34H by pressing the contacting portion 31F when housing the inner conductor 31 in the housing portion 34C. After insertion, the partner connecting portion 31A can then be held in the second housing portion 34H. Since the contacting portion 31F has both a function of contacting the lid portion 34D and a function of being pressed by the lid portion 34D during assembly, the overall configuration can be simplified as compared with the case where both functions are provided in separate portions.

### Other Embodiments of Disclosure

The present disclosure is not limited to the first embodiment illustrated in the above description and drawings. All changes that come within the meaning of equivalency of the claims and fall within the scope of the claims are intended to be embraced in the present invention, and embodiments such as the following are also intended to be embraced therein.

Different from the first embodiment, a configuration may be adopted in which the inner conductor is not provided with the contacting portion.

Different from the first embodiment, a configuration may be adopted in which the wall surface of the upper sidewall portion of the inner conductor is in surface contact with the lid portion.

Different from the first embodiment, a configuration may be adopted in which the rear end of the sidewall portion of the inner conductor is not continuous with the front end of the barrel piece.

### LIST OF REFERENCE NUMERALS

10 Shield terminal
20 Housing
21 Housing recess portion
22 Inserting portion
23 Covering member
31 Inner conductor
31A Partner connecting portion
31B Electric wire connecting portion
31C Coupling portion
31D Base wall portion
31E Sidewall portion
31F Contacting portion
31G Bent portion
31H Flat portion
31J Barrel piece
31K Back surface of contacting portion
32 First outer conductor (outer conductor)
33 Second outer conductor (outer conductor)
34 Dielectric
34A Inserting portion
34B Dielectric main body portion
34C Housing portion
34D Lid portion
34E Hinge portion
34F Stopper surface
34G First housing portion (housing portion)
34H Second housing portion (housing portion)
34J Insertion opening
34K Wall surface demarking second housing portion
35 Barrel portion
36 Base portion
45 Upward extension portion
48 Main body portion
49 Extending portion
51 Lower extension portion
52 Hinge
53 Upper extension portion
54 Elastic contacting portion
56 Open portion
57 Main extension portion
58 Auxiliary extension portion
70 Connector
90 Electric wire
91 Core wire
92 Insulation covering
93 Shield portion
94 Sheath
C Corner portion
F Partner outer conductor
Mt Partner inner conductor
P Wall surface facing stopper surface

1. A shield terminal comprising:
an inner conductor;
an outer conductor; and
a dielectric disposed between the inner conductor and the outer conductor,
wherein the inner conductor has
a partner connecting portion that is connected to a partner inner conductor,
an electric wire connecting portion that is connected to an electric wire; and
a coupling portion disposed between the partner connecting portion and the electric wire connecting portion,
the coupling portion has a base wall portion coupled to the partner connecting portion and the electric wire connecting portion; and
a sidewall portion extending upward from the base wall portion,
the partner connecting portion has a shape extending with respect to the coupling portion in a direction intersecting an alignment direction of the coupling portion and the electric wire connecting portion,
the dielectric has a housing portion housing the inner conductor,
the housing portion has
a first housing portion housing the coupling portion and the electric wire connecting portion;
a second housing portion intersecting the first housing portion and housing the partner connecting portion; and
an insertion opening open at an end portion on one side of the first housing portion and the second housing portion, and
the first housing portion has, at an end portion on another side opposing the insertion opening, a stopper surface facing a wall surface of the sidewall portion in a contactable manner.

2. The shield terminal according to claim 1,
wherein the electric wire connecting portion has a barrel piece extending upward from the base wall portion, and
one end of the sidewall portion is coupled to the barrel piece.

3. The shield terminal according to claim 1,
wherein the dielectric has a lid portion capable of opening and closing the insertion opening, and
the inner conductor has a contacting portion that contacts the lid portion in a closed state.

4. The shield terminal according to claim 3, wherein the contacting portion has a shape that partially blocks the insertion opening at the end portion on the one side relative to the partner connecting portion.
